(19) United States
(12) Patent Application Publication
(10) Pub. No.: US 2024/0383766 A1
(43) Pub. Date: Nov. 21, 2024

(54) ALUMINIUM TRIHYDROXIDE COMPOSITIONS

(71) Applicants: ANKERPOORT N.V., Maastricht (NL); SIBELCO DEUTSCHLAND GMBH, Ransbach-Baumbach (DE)

(72) Inventors: Qadeer ALAM, Maastricht (NL); Gerardus Lambertus CREUSEN, Maastricht (NL); Tanja NEMNICH-MÜLLER, Ransbach-Baumbach (DE); Sara Luisa MARINA BARBIER, Maastricht (NL)

(73) Assignees: ANKERPOORT N.V., Maastricht (NL); SIBELCO DEUTSCHLAND GMBH, Ransbach-Baumbach (DE)

(21) Appl. No.: 18/578,522

(22) PCT Filed: Jul. 11, 2022
(86) PCT No.: PCT/EP2022/069267

§ 371 Date: Jan. 11, 2024

(30) Foreign Application Priority Data
Jul. 12, 2021 (GB) 2109999.9

(51) Int. Cl. C01F 7/021; C08K 3/016; C08K 3/22

(52) U.S. Cl. CPC C01F 7/021; C08K 3/016; C08K 3/22; C01P 2004/51; C01P 2004/61; C01P 2006/10; C01P 2006/14; C08K 2003/2227; C08K 2201/005; C08K 2201/014

(57) ABSTRACT

The present invention relates to aluminium trihydroxide compositions. The present invention also relates to methods of forming aluminium trihydroxide compositions.

### FIELD OF THE INVENTION

The present invention relates to aluminium trihydroxide compositions. The present invention also relates to methods of forming aluminium trihydroxide compositions.

### BACKGROUND OF THE INVENTION

Aluminium trihydroxide (ATH) is commonly used as a flame retardant in a wide range of materials, including but not limited to wires, cables, furniture, transport, electrical products and building materials. Typically, ATH is used as a thermal conductive filler in a polymer matrix (i.e. in a composite with a polymer) such polymer matrices formed from silicones, epoxies, polyesters and/or polyols.

ATH is a preferred flame retardant because ATH is a white powder, has desirable heat dissipation properties, a preferred density (typically 2.42 g/cm³ plus or minus 0.2 g/cm³) and a non-conductive nature with regard to electrical current.

An ATH composition may include ATH with two or more different physical characteristics (such as two or more different particle sizes, two or more different particle size distributions and/or two or more different morphologies). The combination of ATH particles with two or more different physical characteristics provides superior properties in terms of thermal conductivity and viscosity when the resultant ATH composition is used in a polymer matrix, i.e. when included in a polymer composite.

A known ATH composition is APYRAL™ 20X produced by Nabaltec AG. APYRAL™ 20X is believed to be a combination of both ground ATH particles and precipitated ATH particles. APYRAL™ 20X has beneficial viscosity and thermal conductivity properties when used in a polymer composite.

There is a need for ATH compositions having beneficial thermal conductivity and beneficial viscosity properties.

### SUMMARY OF THE INVENTION

The present invention relates to ATH compositions which can be used to replace, in whole or in part, known ATH compositions.

The ATH compositions of the present invention advantageously have the same or similar physical properties to known ATH compositions.

The present invention relates to an ATH composition comprising a combination of ground ATH particles with at least two different physical characteristics. The new ATH compositions advantageously have beneficial thermal conductivity compared to known ATH compositions, and advantageously maintain the same or similar physical properties to known ATH compositions.

Representative features of the present invention are set out in the following clauses, which stand alone or may be combined, in any combination, with one or more features disclosed in the text and/or figures of the specification.

In a first aspect of the present invention, there is provided an aluminium trihydroxide composition, wherein the aluminium trihydroxide composition comprises (or consists of):
from 50 weight % to 85 weight % a first plurality of ground aluminium trihydroxide particles having a maximum dimension of from 50 to 500 μm;
from 15 weight % to 50 weight % a second plurality of ground aluminium trihydroxide particles having a maximum dimension of less than 50 μm; and, optionally,
unavoidable impurities.

Preferably, wherein the first plurality of ground aluminium trihydroxide particles have a maximum dimension of: from 50 to 300 μm; or, from 75 to 250 μm; or, from 100 to 150 μm (plus or minus 50 μm).

Further preferably, wherein the second plurality of ground aluminium trihydroxide particles have a maximum dimension of: less than 40 μm; or, less than 30 μm (plus or minus 5 μm).

Advantageously, wherein the first plurality of ground ATH particles has:
a D10 of from 25 to 40 μm; or from 25 to 35 μm; or from 31 to 33 μm; or 32 μm; and/or,
a D50 of from 90 to 110 pm; or from 100 to 104 μm; or 102 μm; and/or,
a D97 of from 200 to 300 μm; or from 200 to 220 μm; or 210 μm.

Preferably, wherein the second plurality of ground ATH particles has:
a D10 of from 1.0 to 4.0 μm; or from 1.0 to 2.0 μm; or 1.5 μm; and/or,
a D50 of from 6 to 12 μm; or 8 μm; and/or,
a D97 of from 25 to 40 μm; or from 30 to 34 μm; or 32 μm.

Further preferably, wherein the aluminium trihydroxide composition has:
a D10 of from 1 to 3 μm; or 2 μm; and/or,
a D50 of from 20 to 24 μm; or 21.86 μm; and/or,
a D97 of from 180 to 220 μm; or 198 μm.

Preferably, wherein the first plurality of ground aluminium trihydroxide particles have a total cumulative volume of: 76 mm³/g or less; or, from 76 mm³/g to 50 mm³/g; or, from 76 mm³/g to 65 mm³/g.

Further preferably, wherein the first plurality of ground aluminium trihydroxide particles have a Specific Surface Area of: 3 m²/g or less; or, 2.95 m²/g or less; or, from 3 m²/g to 1 m²/g; or, from 2.95 m²/g to 2.8 m²/g.

Advantageously, wherein the aluminium trihydroxide composition comprises the first plurality of ground aluminium trihydroxide particles at: from 60 to 85 weight %; or, from 65 to 80 weight %; or, from 70 to 80 weight %; or, from 55 to 65 weight %.

Preferably, wherein the aluminium trihydroxide composition comprises the second plurality of ground ATH particles at: from 15 to 40 weight %; or, from 20 to 35 weight %; or, from 20 to 30 weight %; or, from 35 to 45 weight %.

Further preferably, wherein: the first plurality of ground aluminium trihydroxide particles have a maximum dimension of 300 μm; and,
the second plurality of ground aluminium trihydroxide particles have a maximum dimension of 30 μm.

Advantageously, wherein the ratio of the first plurality of aluminium trihydroxide particles to the second plurality of aluminium trihydroxide particles in the aluminium trihydroxide composition is (in weight %):12.5 (first):3.5 (second), plus or minus 2.5 for each; or, 8 (first):1.5 (second), plus or minus 0.5 for each; or, 10 (first): 5 (second), plus or minus 1 for each; or, 4 (first):2.2 (second), plus or minus 0.5 for each.

Preferably, wherein the ratio of the first plurality of ground aluminium trihydroxide particles to the second plurality of ground aluminium trihydroxide particles results in: 40 or less % v/v voids (or pores) in the aluminium trihydroxide composition; or, 34 or less % v/v voids (or pores) in the aluminium trihydroxide composition.

Further preferably, wherein the aluminium trihydroxide composition has a density of 2.42 g/cm³ (plus or minus 0.2 g/cm³).

Advantageously, wherein the aluminium trihydroxide composition has a homogeneous particle distribution for both the first plurality of ground ATH particles and the second plurality of ground ATH particles.

Preferably, wherein the particles in the aluminium trihydroxide composition have a maximum dimension distribution of from 0.1 to 305 μm.

According to a further aspect of the present invention, there is provided a process for making an aluminium trihydroxide composition, the process comprising the following steps:
providing a first plurality of ground aluminium trihydroxide particles, having a maximum dimension of from 50 to 500 μm at from 50 weight % to 85 weight %; and,
providing a second plurality of ground aluminium trihydroxide particles, having a maximum dimension of less than 50 μm at from 15 weight % to 50 weight %; and,
mixing the first plurality of ground aluminium trihydroxide particles and the second plurality of ground aluminium trihydroxide particles.

Preferably, wherein the aluminium trihydroxide composition, the first plurality of ground aluminium trihydroxide particles and/or the second plurality of ground aluminium trihydroxide particles are as in any one of claims 1 to 14.

Further preferably, wherein the step of mixing is carried out for: from 0.1 to 8 hours at 25° C.; or, from 0.3 to 4 hours at 25° C.; or, from 0.5 to 2 hours at 25° C.; or, until a mixture with a homogeneous particle distribution is formed at 25° C.

Advantageously, wherein the ratio of the first plurality of ground aluminium trihydroxide particles to the second plurality of ground aluminium trihydroxide particles in the mixture is (in weight %):12.5 (first):3.5 (second), plus or minus 2.5 for each; or, 8 (first):1.5 (second), plus or minus 0.5 for each; or, 10 (first):5 (second), plus or minus 1 for each; or, 4 (first):2.2 (second), plus or minus 0.5 for each.

According to a further aspect of the present invention, the aluminium trihydroxide composition is for use as a flame retardant and/or as a thermal management filler.

According to a further aspect of the present invention, there is provided a polymer composite comprising a polymer and the aluminium trihydroxide composition of the present invention.

Preferably, wherein the polymer is a polymer formed from silicones, epoxies, polyesters, polyethylene wax and/or polyols; optionally, wherein the polymer is a thermoset polymer or a thermoplastic polymer.

Further preferably, wherein the polymer composite comprises (in weight %):
50 to 90 aluminium trihydroxide composition of any one of claims 1 to 14; and,
10 to 50 polymer; or
60 to 80 aluminium trihydroxide composition of any one of claims 1 to 14; and,
20 to 40 polymer.

Advantageously, wherein the polymer composite has a thermal conductivity of: from 2 to 7 W/mK; from 2 to 4 W/mK; or, from 2.5 to 3 W/mK; or, from 2.6 to 2.9 W/mK; or, from 2.8 to 2.9 W/mK.

Preferably, wherein the polymer composite has a viscosity of: 13 Pa·s or less; or, 11 Pa·s or less; or, 9 Pa·s or less.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein.

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

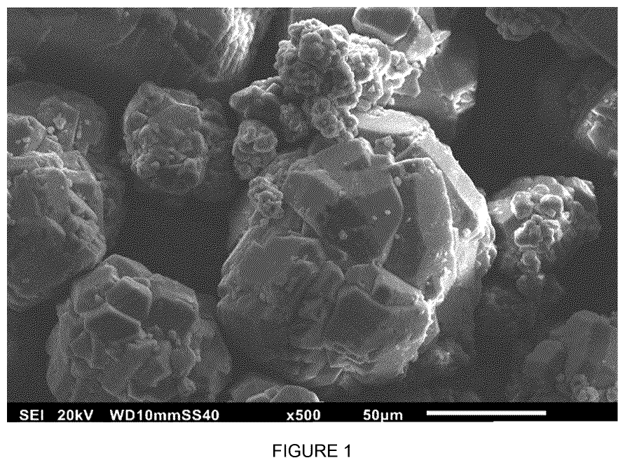

FIG. 1 is a scanning electron microscope (SEM) image showing the morphology of a first (coarse) plurality of ground ATH particles.

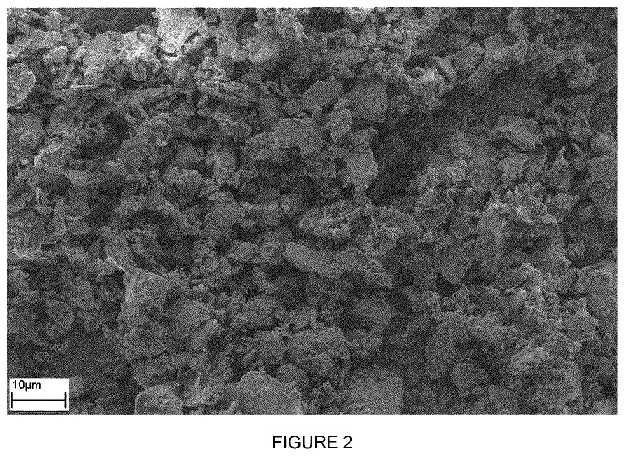

FIG. 2 is a SEM image showing the morphology of a second (fine) plurality of ground ATH particles.

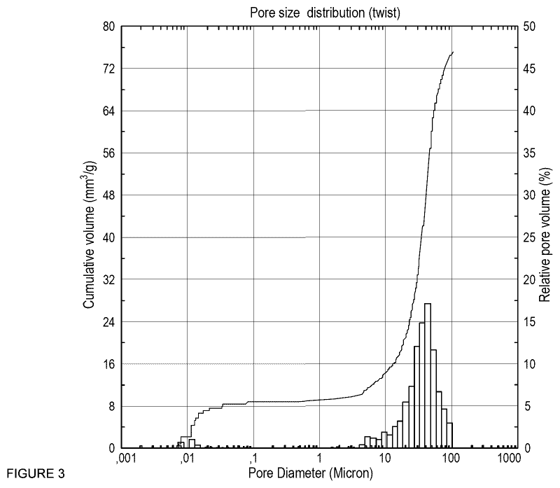

FIG. 3 is a pore size distribution of a first (coarse) plurality of ground ATH particles (the first (coarse) plurality of ground ATH particles included in the ATHE1, ATHE2 and ATHE3 compositions; referred to as Coarse A).

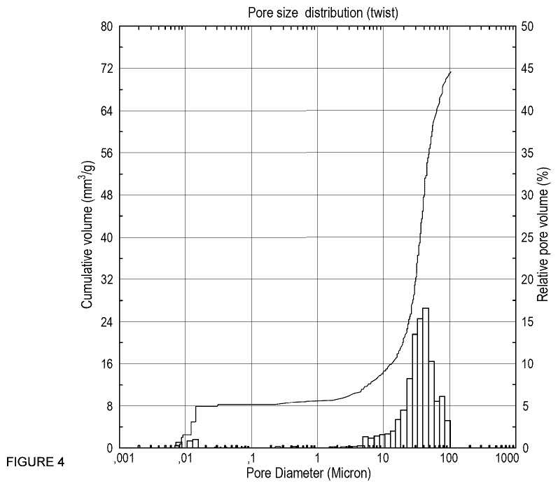

FIG. 4 is a pore size distribution of a first (coarse) plurality of ground ATH particles (the first (coarse) plurality of ground ATH particles included in the BORATHERM™ SG-200LVS composition; referred to as Coarse B).

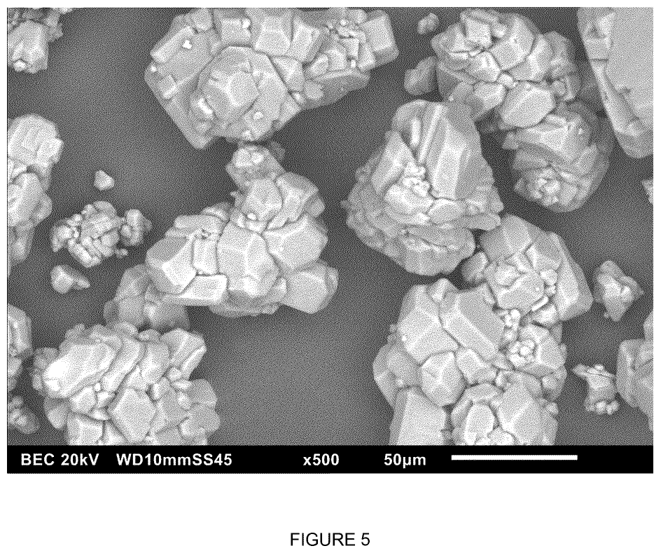

FIG. 5 is a SEM image showing the morphology of the first (coarse) plurality of ground ATH particles of FIG. 3 (Coarse A).

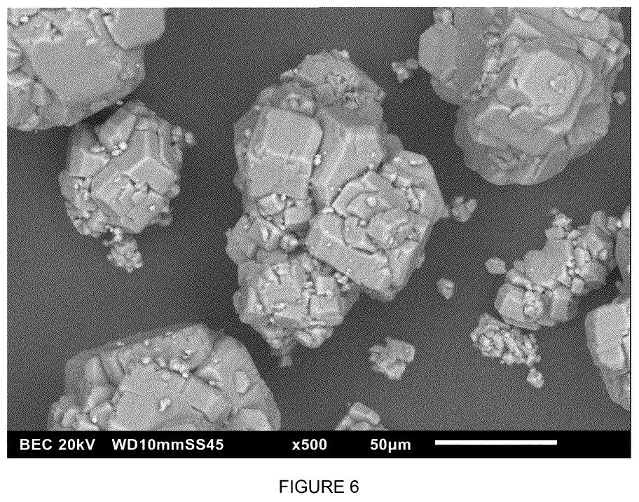

FIG. 6 is a SEM image showing the morphology of the first (coarse) plurality of ground ATH particles of FIG. 4 (Coarse B).

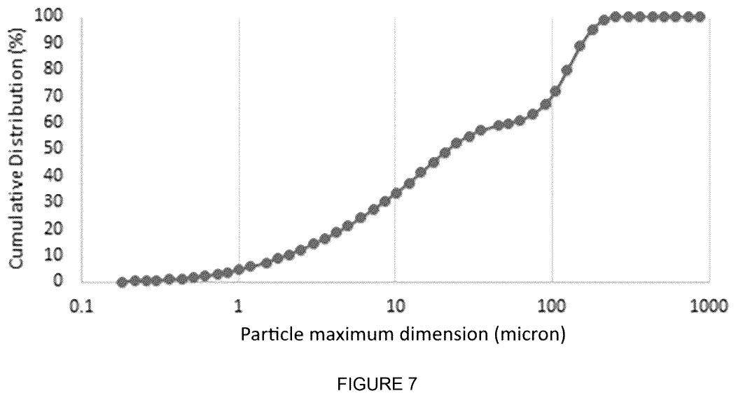

FIG. 7 is a graph plotting the particle dimension distribution of an exemplary ATH composition as a cumulative curve (adding up to 100).

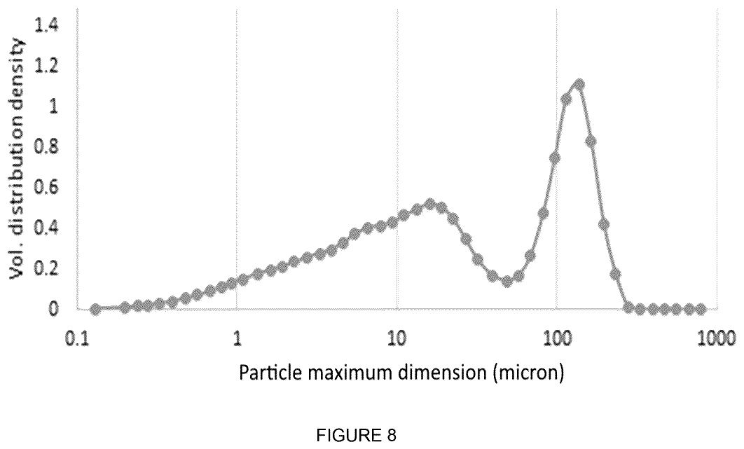

FIG. 8 is a graph plotting the particle dimension distribution of the same ATH composition as FIG. 7, the particle dimension distribution displayed as a relative distribution.

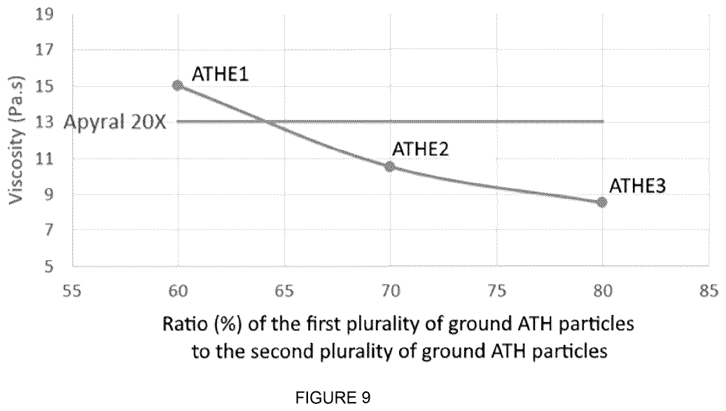

FIG. 9 is a plot of the viscosity of three different ATH compositions of the present invention comprising different ratios of a first (coarse) plurality of ground ATH particles to a second (fine) plurality of ground ATH particles.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. The terms are not to be interpreted to exclude the presence of other features, steps or components. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Some of the terms used to describe the present invention are set out below:

“Aluminium trihydroxide (ATH)” refers to an inorganic mineral with the chemical formula Al(OH)₃. Aluminium trihydroxide predominantly exists naturally as gibbsite and in three rarer polymorphs: bayerite, doyleite and nordstrandite. Aluminium trihydroxide may also be referred to as aluminium hydroxide.

“APYRAL™ 20X” refers to a product currently sold by Nabaltec AG. APYRAL™ 20X is a combination of ground aluminium trihydroxide and precipitated aluminium trihydroxide. APYRAL™ 20X has useful viscosity and thermal conductivity properties when used in a polymer composite.

“Bayer process” refers to a process in which aluminium trihydroxide is formed from bauxite and sodium hydroxide. The process involves dissolving bauxite in sodium hydroxide at temperatures of up to 270° C. The waste solid, which is known as bauxite tailings, is removed and aluminium trihydroxide is precipitated from the remaining solution of sodium aluminate.

“Bauxite” refers to a rock formed from a reddish clay material. Bauxite primarily comprises alumina, silica, iron oxides and titanium oxides.

“BORATHERM™ SG-200LVS” refers to an ATH product produced by Sibelco™ BORATHERM™ SG-200LVS contains a mixture of two different kinds of ground ATH particles.

“D10” refers to the particle maximum dimension at 10% in a cumulative distribution of maximum dimensions of particles in a mixture of particles.

“D50” refers to the particle maximum dimension at 50% in a cumulative distribution of maximum dimensions of particles in a mixture of particles. D50 is sometimes referred to as the median maximum dimension in a particle size distribution.

“D97” refers to the particle maximum dimension at 97% in a cumulative distribution of maximum dimensions of particles in a mixture of particles.

“Flame retardant” refers to a composition that can prevent fires from starting or that can slow the spread of fire.

“Ground aluminium trihydroxide” refers to an aluminium trihydroxide powder which is precipitated from bauxite tailings and subsequently undergoes particle size reduction via milling and/or sieving operations. Ground aluminium trihydroxide is often formed by a grinder grinding the particles to a maximum dimension of less than 300 μm. Examples of grinders include jet mills, ball mills and roller mills.

“Maximum dimension” refers to the longest cross-sectional dimension of any particular particle. Aluminium trihydroxide particles according to the compositions of the present invention can have a variety of shapes, including but not limited to: generally (although not perfectly) spherical, rod-like, cylindrical, cone-like, cube-like, cuboid, tetrahedral or irregular three dimensional.

“OCTEO” refers to a product currently sold by Evonik Operations GmbH. Dynasylan® OCTEO is a monomeric medium-chain N-Octyl Triethoxy Silane. Dynasylan® OCTEO is a surface modifier to generate hydrophobicity on inorganic fillers for compatibility improvements purposes.

“Precipitated aluminium trihydroxide” refers to ATH that undergoes precipitation two times. Firstly, from bauxite tailings; followed by reprecipitation, to control particle morphology and size. Precipitated ATH is more difficult to form and more expensive than Ground ATH.

“SEM” refers to a scanning electron microscope. A non-limiting example of a scanning electron microscope is a JSM-IT800, as sold by JEOL™.

“Specific Surface Area” refers to the area of solid surface per unit mass of a material. Specific surface area can be measured by mercury intrusion porosimetry, optionally using a Pascal 100 Series (as sold by Thermo Electron) and/or a Pascal 240 Series (as sold by Thermo Electron).

“Total cumulative volume” refers to the total cumulative pore volume per unit mass occupied by a substance (for example mercury) with increasing pressure. Total cumulative volume can be measured by mercury intrusion porosimetry, optionally using a Pascal 100 Series (as sold by Thermo Electron) and/or a Pascal 240 Series (as sold by Thermo Electron).

“Unavoidable impurities” refers to components present in a composition which do not affect the properties of the composition. Unavoidable impurities are present in a composition at: less than 5 weight %; or, less than 4 weight %; or, less than 3 weight %; or, less than 2 weight %; or, less than 1 weight %; or less than 0.5 weight %; or less than 0.1 weight %.

“% v/v” refers to volume/volume percentage. For example, if a composition contains 40 or less % v/v voids (or pores), for every 100 mL of composition there are 40 or less mL voids (or pores).

“Weight %” refers to the percentage weight in grams of a component of a composition in every 100 grams of a composition. For example, if a composition contains 10 weight % of component A, then there is 10 g of component A for every 100 g of the composition.

### Composition of the Aluminium Trihydroxide Composition (ATH Composition)

In examples of the present invention, an aluminium trihydroxide (ATH) composition is formed from ground ATH. Ground ATH is formed from a less complicated production process than precipitated ATH. Previously, both ground ATH and precipitated ATH were used because precipitated ATH can be formed with control over morphology of the ATH particles. The present inventors surprisingly found that ground ATH (only, i.e. absent any precipitated ATH) can be used to make beneficial ATH compositions.

In this example of the present invention, the ATH composition comprises a first (coarse) plurality of ground ATH particles and a second (fine) plurality of ground ATH particles.

Optionally, the particles of the first (coarse) plurality of ground ATH particles can comprise a coating, the second (fine) plurality of ground ATH particles can comprise a coating, or the first (coarse) plurality and the second (fine) plurality of ground ATH particles can comprise a coating. The coating can include one or more of: fatty acids and/or organosilanes. Coatings can be included to provide beneficial dispersion, rheology and/or interfacial compatibility.

In some examples of the present invention, the first (coarse) plurality of ground ATH particles have a maximum dimension of from 50 to 500 μm, 50 to 300 μm, or from 75 to 250 μm, or from 100 to 150 μm (plus or minus 50 μm).

In some examples of the present invention, the second (fine) plurality of ground ATH particles have a maximum dimension of less than 50 μm, or less than 40 μm, or less than 30 μm (plus or minus 5 μm). The second (fine) plurality of ground ATH particles can have a maximum dimension of greater than 0.5 μm, or greater than 1 μm

In some examples of the present invention, the ATH composition comprises a first (coarse) plurality of ground ATH particles with a maximum dimension of 200 μm (plus or minus 50 μm) and a second (fine) plurality of ground ATH particles with a maximum dimension of 30 μm (plus or minus 5 μm).

In some examples of the present invention, the first (coarse) plurality of ground ATH particles has: a D10 of from 25 to 40 μm, or from 25 to 35 μm, or from 31 to 33 μm, or 32 μm; and, a D50 of from 90 to 110 μm, or from 100 to 104 μm, or 102 μm; and, a D97 of from 200 to 300 μm, or from 200 to 220 μm, or 210 μm.

In some examples of the present invention, the second (fine) plurality of ground ATH particles has: a D10 of from 1.0 to 4.0 μm, or from 1.0 to 2.0 μm, or 1.5 μm; and, a D50 of from 6 to 12 μm; or 8 μm; and, a D97 of from 25 to 40 μm, or from 30 to 34 μm, or 32 μm.

In some examples of the present invention, the ATH composition has a D10 of from 1 to 3 μm, or 2 μm; and, a D50 of 20 to 24 μm, or 21.86 μm; and, a D97 of from 180 to 220 μm, or 198 μm.

In some examples of the present invention, the ATH composition comprises ATH particles with a maximum dimension distribution of from 0.1 to 305 μm.

In some examples of the present invention, the ATH composition comprises the first (coarse) plurality of ground ATH particles at from 50 to 85 weight %, or from 60 to 85 weight %, or from 65 to 80 weight %, or from 70 to 75 weight %.

In some examples of the present invention, the ATH composition comprises the second (fine) plurality of ground ATH particles at from 15 to 50 weight %, or from 15 to 40 weight %, or from 20 to 35 weight %, or from 25 to 30 weight %.

In some examples of the present invention, the ratio (by weight) of the first (coarse) plurality of ground ATH particles to the second (fine) plurality of ground ATH particles in the ATH composition is: 12.5 (coarse):3.5 (fine) respectively, or 8 (coarse):1.5 (fine) respectively, or 10 (coarse):5 (fine) respectively, or 4 (coarse):2.2 (fine) respectively, plus or minus 0.5 for each.

In some examples of the present invention, the ratio of the first (coarse) plurality of ground ATH particles to the second (fine) plurality of ground ATH particles results in: 40 or less % v/v voids (or pores) in the ATH composition; or, 34 or less % v/v voids (or pores) in the ATH composition.

Advantageously, the ATH composition of the present invention has the same or similar physical properties to known ATH compositions.

In some examples of the present invention, the ATH composition advantageously has a beneficial thermal conductivity compared to known ATH compositions when in a polymer matrix. Preferably, the thermal conductivity of the ATH composition (when in a polymer matrix with a linear, non-reactive polydimethylsiloxane; the loading of ATH composition in the polymer is 87.5 weight % ATH composition with 12.5 weight % polymer) is from 2.6 to 2.9 W/mK (or 2.8 to 2.9 W/mK). Advantageously, the improved thermal conductivity aids the rheological and thermal properties of the ATH composition (i.e. heat dissipation is improved). For example, a more favourable thermal conductivity results in the ATH composition conducting more heat energy and therefore acting as a beneficial flame or heat retardant.

In some examples of the present invention, the ATH composition advantageously has a beneficial viscosity compared to known ATH compositions, when in a polymer matrix. Optionally, the viscosity of the ATH composition is 13 Pa·s or less, or 11 Pa·s or less, or 9 Pa·s or less, or from 8 to 9 Pa·s. Advantageously, the improved viscosity results in better flow properties for the ATH composition of the present invention, such as self-levelling behaviour.

In some examples of the present invention, the ATH composition has a beneficial density of 2.42 g/cm³ (plus or minus 0.2 g/cm³).

### Formation of Aluminium Trihydroxide Composition (ATH Composition)

In some examples of the present invention, ATH is sourced from bauxite which has undergone the Bayer process.

The ATH composition is formed from different ground ATH particles.

The ATH composition comprises a first (coarse) plurality of ground ATH particles and a second (fine) plurality of ground ATH particles. Before mixing, the first (coarse) plurality of ground ATH particles and a second (fine) plurality of ground ATH particles are separately sieved (to the desired sizes) and any undesirable impurities are removed. The first (coarse) plurality of ground ATH particles and the second (fine) plurality of ground ATH particles are then mixed.

The first (coarse) plurality of ground ATH particles and the second (fine) plurality of ground ATH particles are mixed for: from 0.1 to 8 hours at 25° C.; or, from 0.3 to 4 hours at 25° C.; or, from 0.5 to 2 hours at 25° C.; or, until a mixture with a homogeneous particle distribution is formed at 25° C.

The ratio of the first (coarse) plurality of ground ATH particles to the second (fine) plurality of ground ATH particles in the mixture is: 12.5 (fine):3.5 (coarse) respectively; or, 8 (coarse):1.5 (fine) respectively; or, 10 (fine):5 (coarse) respectively; or, 4 (coarse):2.2 (fine) respectively.

The step of mixing uses any known method of mixing. For example, mixing can use low shear mixing in a horizontal shaft mixer. In some examples, mixing occurs in a horizontal ribbon mixer, as sold by Gebrüder Lödige Maschinenbau GmbH.

The resultant mixture has a homogeneous particle distribution for both the first (coarse) plurality of ground ATH particles and the second (fine) plurality of ground ATH particles. By having a homogeneous particle distribution, the ATH particles of all sizes are well mixed.

Advantageously, mixing causes the resultant ATH composition to be formed of particles having a broad particle dimension distribution of from 0.1 to 500 μm. This is attributed to the first (coarse) plurality of ground ATH particles assisting with the deagglomeration of the second (fine) plurality of ground ATH particles during the step of mixing, owing to the friability of the second (fine) plurality of ground ATH particles. Without wishing to be bound by theory, it is believed that including a first (coarse) plurality of ground ATH particles and a second (fine) plurality of ground ATH particles leads to beneficial packing of the different particle sizes, leading to beneficial viscosity, density and thermal conductivity properties.

Advantageously, the mixing action results in a compact ATH composition having: from 40 or less % v/v voids (or pores) in the ATH composition; or, from 34 or less % v/v voids (or pores) in the ATH composition. As a result, the ATH composition is able to form high filler loadings in a polymer matrix.

Advantageously, the mixing action results in an ATH composition having a viscosity of: 13 Pa·s or less; or, 11 Pa·s or less; or, 9 Pa·s or less; for a given polymer matrix. The resultant ATH composition is free-flowing.

### EXAMPLES

The following are non-limiting examples that discuss, with reference to tables and figures, the advantages of the present invention. The examples set forth herein are non-limiting examples and are merely examples among other possible examples.

### Example 1: Comparison of the Starting Materials

The following non-limiting example compares the morphology of the first (coarse) plurality of ground ATH particles to the second (fine) plurality of ground ATH particles, each of which are included in the ATH compositions of the present invention.

FIG. 1 is a SEM image showing the morphology of the first (coarse) plurality of ground ATH particles in one non-limiting example. As shown in FIG. 1, the morphology of the first (coarse) plurality of ground ATH particles is compact, dense and has fewer pores on the surface.

FIG. 2 is a SEM image showing the morphology of the second (fine) plurality of ground ATH particles in one non-limiting example. As shown in FIG. 2, the morphology of the second (fine) plurality of ground ATH particles is smaller in size and comprises an agglomeration of particles.

From comparing FIGS. 1 and 2, it is observed that the morphology of the first (coarse) plurality of ground ATH particles is significantly more compact and/or homogeneous than the morphology of the second (fine) plurality of ground ATH particles.

Advantageously, through forming an ATH composition from the first (coarse) plurality of ground ATH particles and the second (fine) plurality of ground ATH particles, ATH compositions can be formed with 40 or less % v/v voids (or pores) in the aluminium trihydroxide compositions.

### Example 2: Comparison of the Coarse Fraction Materials

The following non-limiting example compares the morphology of two coarse fraction materials (Coarse A and Coarse B), each of which can be included in the ATH compositions of the present invention. The first coarse material (Coarse A) is included in the example ATHE1, ATHE2 and ATHE3 compositions, while the second coarse material (Coarse B) is included in the BORATHERM™ SG-200LVS composition.

FIG. 3 is a pore size distribution of a first (coarse) plurality of ground ATH particles (the first (coarse) plurality of ground ATH particles included in the ATHE1, ATHE2 and ATHE3 compositions; Coarse A).

FIG. 4 is a pore size distribution of a first (coarse) plurality of ground ATH particles (the first (coarse) plurality of ground ATH particles included in the BORATHERM™ SG-200LVS composition; Coarse B).

As shown in FIGS. 3 and 4, the pore size distribution of Coarse B is larger than the pore size distribution of Coarse A. The pore size distributions of FIGS. 3 and 4 were determined by mercury intrusion porosimetry using a Pascal 100 Series and a Pascal 240 Series (as sold by Thermo Electron).

TABLE 1
Total cumulative volume and total specific surface area of
Coarse A and Coarse B.

| | Total cumulative | Specific |
|---|---|---|
| | volume/ | Surface |
| Sample | mm³/g | Area/m²/g |
| Coarse A (ATHE1, ATHE2 and | 75.1 | 2.92 |
| ATHE3) | | |
| Coarse B (BORATHERM200LVS) | 80.2 | 3.24 |

Advantageously, through forming an ATH composition comprising Coarse A, ATH compositions can be formed with 40 or less % v/v pores (or voids) in the aluminium trihydroxide compositions.

FIG. 5 is a SEM image showing the morphology of Coarse A.

FIG. 6 is a SEM image showing the morphology of Coarse B.

Advantageously, the morphology of Coarse A, is composed of more large particles compared to Coarse B, which presents a less compact and less homogeneous morphology composed of small and large particles. Additionally, Coarse B presents a morphology with more damaged edges creating more porosity and higher specific surface area. Without wishing to be bound by theory, it is believed that an aluminium trihydroxide composition comprising a first (coarse) plurality of ground aluminium trihydroxide particles with a total cumulative volume of 76 mm³/g or less, provides ATH compositions with 40 or less % v/v pores (or voids) in the aluminium trihydroxide compositions. Furthermore, without wishing to be bound by theory, it is believed that an aluminium trihydroxide composition comprising a first (coarse) plurality of ground aluminium trihydroxide particles with a Specific Surface Area of 3 m²/g or less, provides ATH compositions with 40 or less % v/v pores (or voids) in the aluminium trihydroxide compositions.

Advantageously, through forming ATH compositions comprising the first (coarse) plurality being Coarse A, and polymer composites comprising those ATH compositions, relatively high thermal conductivity values are obtained.

### Example 3: Maximum Dimension Distribution of Particles in the ATH Composition

The following non-limiting example compares the maximum dimension distribution of particles in the ATH composition of the present invention.

FIG. 7 shows the distribution of maximum dimension sizes for particles in an example ATH composition, referred to as ATHE2, as a function of cumulative distribution adding up to 100. In ATHE2, the ratio of the first (coarse) plurality of ground ATH particles to the second (fine) plurality of ground ATH particles was (in weight %) 70 (coarse): 30 (fine). FIG. 8 shows the maximum dimension distribution of the particles in ATHE2 as a function of relative distribution. The maximum dimension distributions of FIGS. 7 and 8 were determined using a HELOS laser diffraction instrument (as sold by Sympatec GmbH).

Each sample was dispersed in water (using stirring and sonication) and laser diffraction was used to determine the maximum dimension distribution of particles. A HELOS laser diffraction instrument (as sold by Sympatec GmbH) was used for the measurement. Mie's scattering theory was applied to the scattering data to determine the maximum dimension of the particles within ATHE2.

As shown in FIGS. 7 and 8, a unique maximum dimension distribution is achieved wherein particles in ATHE2 have a broad maximum dimension distribution of from 0.1 to 305 μm. This result can be attributed to the first (coarse) plurality of ground ATH particles being broken apart and the second (fine) plurality of ground ATH particles being de-agglomerated during the step of mixing.

### Example 4: Analysing the Effect of the Ratio of the First (Coarse) Plurality of Ground ATH Particles to the Second (Fine) Plurality of Ground ATH Particles on the Physical Properties of the ATH Composition

The following non-limiting example analyses the change in physical properties arising from a change in the ratio of the first (coarse) plurality of ground ATH particles to the second (fine) plurality of ground ATH particles in the ATH composition.

Three different ATH compositions were prepared. The ratio of the first (coarse) plurality of ground ATH particles to the second (fine) plurality of ground ATH particles in each composition was (in weight %):60 (coarse):40 (fine) (ATHE1);70 (coarse):30 (fine) (ATHE2); and, 80 (coarse):20 (fine) (ATHE3), respectively.

The known ATH compositions were APYRAL™ 20X and BORATHERM™ SG-200LVS.

Three different ATH compositions of the present invention (ATHE1, ATHE2 and ATHE3) and the known ATH compositions APYRAL™ 20X and BORATHERM™ SG-200LVS were individually added to a siloxane to form a composite (each separately). The composites comprised each ATH composition at 70 weight %, the remainder being the siloxane. The siloxane used was polydimethylsiloxane having a viscosity of approximately 500 mm²/s at 30° C. with a shear rate of 10 m/s. Before a viscosity measurement was taken, each ATH composition was well dispersed in the siloxane matrix by a high speed dual asymmetric centrifuge at 3000 rpm for 1 minute, and then allowed to settle in an oven for ten minutes at 30° C. Before a viscosity measurement was taken, the build-up structure was removed by manual stirring with a spatula.

The viscosity of each solution (siloxane with ATH composition) was measured using a Brookfield cone/plate viscometer having a spindle NR-52.

FIG. 9 plots the viscosity of three different ATH compositions of the present invention (ATHE1, ATHE2 and ATHE3) and the viscosity of the known ATH composition, APYRAL™ 20X, when in the described siloxane. As shown in FIG. 9, the viscosity of the ATH compositions of the present invention having a ratio of 70:30 (ATHE2) and 80:20 (ATHE3) is lower than the viscosity of the known ATH composition APYRAL™ 20X. Advantageously, the lower viscosity results in better flow properties for the ATH composition of the present invention (when in the siloxane matrix), such as self-levelling behaviour.

Tables 2A and 2B compare the density and heat capacity for the three example ATH compositions (ATHE1, ATHE2 and ATHE3) of the present invention with known ATH compositions APYRAL™ 20X and BORATHERM™ SG-200LVS.

TABLE 2A
Comparing the density and heat capacity for the three example ATH
compositions (ATHE1, ATHE2 and ATHE3) of the present invention
with the known ATH compositions, when in a composite with a
siloxane polymer. (Thermal effusivity was measured precisely; density
and heat capacity are approximate measurements
based on known properties of the samples).

| | Thermal | | Heat Capacity |
|---|---|---|---|
| | Effusivity/ | | (Cₚ at 23° C)/ |
| Sample | Ws½/m²K | Density/kg/m³ | J/KgK |
| APYRAL ™ 20X | 2488 | 2030 | 1100 |
| BORATHERM ™ | 2424 | 2030 | 1100 |
| SG-200LVS | | | |
| Ratio 60:40 (ATHE1) | 2530 | 2030 | 1100 |
| Ratio 70:30 (ATHE2) | 2504 | 2030 | 1100 |
| Ratio 80:20 (ATHE3) | 2411 | 2030 | 1100 |

TABLE 2B
Comparing the density and heat capacity for the three example ATH
compositions (ATHE1, ATHE2 and ATHE3) of the present invention
with the known ATH compositions, when in a composite with a siloxane
polymer. (These are precise measurements for all of thermal effusivity,
density and heat capacity, taken following the approximate
measurements of Table 2A).

| | Thermal | | Heat Capacity |
|---|---|---|---|
| | Effusivity/ | | (Cₚ at 23° C.)/ |
| Sample | Ws½/m²K | Density/kg/m³ | J/KgK |
| APYRAL ™ 20X | 2497 | 2049 | 1100 |
| BORATHERM ™ | 2408 | 2049 | 1160 |
| SG-200LVS | | | |
| Ratio 60:40 (ATHE1) | 2515 | 2034 | 1040 |
| Ratio 70:30 (ATHE2) | 2513 | 2062 | 1150 |
| Ratio 80:20 (ATHE3) | 2418 | 2070 | 1100 |

As shown in Tables 2A and 2B, the ATH compositions of the present invention have similar density and heat capacity properties as the known ATH compositions, when in a composite with a siloxane polymer.

### Example 5: Comparing the Thermal Conductivity of the ATH Compositions of the Present Invention with Known ATH Compositions

The following non-limiting example compares the thermal conductivity of ATH compositions of the present invention with known ATH compositions.

Three different ATH compositions were made. The ratio of the first (coarse) plurality of ground ATH particles to the second (fine) plurality of ground ATH particles in each composition was (in weight %): 60:40 (ATHE1); 70:30 (ATHE2); and, 80:20 (ATHE3), respectively.

The known ATH compositions used were APYRAL™ 20X and BORATHERM™M SG-200LVS.

The three different ATH compositions (ATHE1, ATHE2 and ATHE3) of the present invention and the known ATH compositions were individually added to siloxane to form a composite. The composite comprised each ATH composition at 87.5 weight %, the remainder being the siloxane. Before a thermal conductivity measurement was taken, each ATH composition was well dispersed in the siloxane matrix by a high speed dual asymmetric centrifuge at 3000 rpm for 1 minute, and then allowed to cool down before performing the measurement.

The thermal effusivity of each composite was measured using a modified transient plane source sensor attached with a Trident™ thermal conductivity measuring instrument, as sold by C-Therm Technologies Ltd. These thermal effusivity values along with density and heat capacity were later used to obtain thermal conductivity of the composite. The thermal effusivity values are tabulated in Table 1. The thermal conductivity, in each case, was calculated using the following equation:

$$e = \sqrt{( λ \cdot ρ \cdot {C}_{p} )}$$

Where e is thermal effusivity, λ is thermal conductivity, ρ is the density of the composite and Cₚ is the specific heat capacity of the composite at a given temperature.

Table 3 shows the thermal conductivity of the ATH compositions of the present invention and the known ATH compositions APYRAL™ 20X and BORATHERM™ SG-200LVS, when in the described siloxane matrix (i.e. in a composite with the siloxane polymer).

TABLE 3A
The thermal conductivity of the ATH composition of the present invention and
the known ATH compositions APYRAL ™ 20X and BORATHERM ™ SG-
200LVS, when in a composite with a siloxane polymer. (These are
approximate measurements using the data from Table 2A).

| | Thermal conductivity |
|---|---|
| Sample | W/mK (at 23° C.) |
| APYRAL ™ 20X | 2.78 |
| BORATHERM ™ SG-200LVS | 2.64 |
| Ratio 60:40 (ATHE1) | 2.87 |
| Ratio 70:30 (ATHE2) | 2.81 |
| Ratio 80:20 (ATHE3) | 2.60 |

TABLE 3B
The thermal conductivity of the ATH composition of the present invention and
the known ATH compositions APYRAL ™ 20X and BORATHERM ™ SG-
200LVS, when in a composite with a siloxane polymer. (These are precise
measurements using the data from Table 2B).

| | Thermal conductivity |
|---|---|
| Sample | W/mK (at 23° C.) |
| APYRAL ™ 20X | 2.77 |
| BORATHERM ™ SG-200LVS | 2.44 |
| Ratio 60:40 (ATHE1) | 2.99 |
| Ratio 70:30 (ATHE2) | 2.66 |
| Ratio 80:20 (ATHE3) | 2.57 |

ATH compositions of the present invention have improved (higher) thermal conductivity values, which advantageously aids the rheological and thermal properties of the ATH composition. The higher thermal conductivity of the example ATH compositions means that filler loading level in a polymer matrix can be kept to a minimum, leading to lower density polymer composites.

### Example 6: Comparing Particle Maximum Dimension Distribution of the ATH Compositions of the Present Invention to Known ATH Compositions

The following non-limiting example compares the particle maximum dimension distribution of the components of the example ATH compositions with a known ATH composition.

The known ATH composition was BORATHERM™ SG-200LVS.

Each sample was dispersed in water (using stirring and sonication) and laser diffraction was used to determine the maximum dimension distribution of the ATH particles. A HELOS laser diffraction instrument (as sold by Sympatec GmbH) was used for the measurement. Mie's scattering theory was applied to the scattering data to determine the maximum dimension of the particles of the components within ATHE1, ATHE2 and ATHE3.

The particle maximum dimension distributions are shown in Table 4.

TABLE 4
The particle maximum dimension distribution of the components of
the ATH compositions (ATHE1, ATHE2 and ATHE3) of the present
invention compared with a known ATH composition.

| | D10 | D50 | D97 |
|---|---|---|---|
| Sample | μm | μm | μm |
| BORATHERM ™ SG-200LVS | 3.00 | 55.00 | 160.00 |
| First (coarse) plurality of ground | 32 | 102 | 210 |
| ATH particles included in | | | |
| ATHE1, ATHE2 and ATHE3 | | | |
| Second (fine) plurality of | 1.5 | 8 | 32 |
| ground ATH particles included | | | |
| in ATHE1, ATHE2 and ATHE3 | | | |

As shown in Table 4, the components of the ATH compositions of the present invention have different particle maximum dimension distributions. The different particle maximum dimension distributions provide beneficial packing of the ATH particles in the ATH compositions of the present invention.

### Example 7: Comparing the Thermal Conductivity of an ATH Composition of the Present Invention with a Known ATH Composition in a Thermoplastic Polymer Matrix

The following non-limiting example compares the changes in thermal conductivity of the 70:30 (ATHE2) ATH composition of the present invention with the known ATH compositions APYRAL™ 20X upon compounding in a different polymer matrix. Each sample was individually coated with 1% OCTEO. Then, each sample was added to a polyethylene wax (PE Wax) matrix to form a composite. The composite comprised each ATH composition at 87.5 weight %.

Before a thermal conductivity measurement was taken, each ATH composition was well dispersed in the polyethylene wax. For polyethylene composite the ATH composition was dispersed in the polymer's melted state. After, the mixture was well dispersed by a high speed dual asymmetric centrifuge at 3000 rpm for 1 minute. Both systems were then allowed to cool down before performing the measurement.

The thermal effusivity of the composite was measured using the same approach as in Example 5.

Table 5 compares the density and heat capacity for the ATH composition of the present invention 70:30 (ATHE2) and the known ATH composition APYRAL™ 20X, in polyethylene wax.

TABLE 5
Comparing the density and heat capacity for the ATH composition of the
present invention 70:30 (ATHE2) and the known ATH composition
APYRAL ™ 20X, when in a composite with a polyethylene wax.

| | | | | Heat |
|---|---|---|---|---|
| | | Thermal | | Capacity |
| | Polymer | Effusivity/ | Density/ | (Cₚ at 23° |
| Sample | Matrix | Ws½/m²K | kg/m³ | C.)/J/KgK |
| APYRAL ™ 20X | PE Wax | 2475 | 1987 | 1240 |
| Ratio 70:30 (ATHE2) | PE Wax | 2669 | 1932 | 1290 |

As shown in Table 5, the ATH composition of the present invention has slightly lower density and slightly higher heat capacity properties compared with the known ATH composition, when in a composite with a polyethylene wax.

Table 6 shows the thermal conductivity of the ATH composition of the present invention 70:30 (ATHE2) and the known ATH composition APYRAL™ 20X, when in the described polyethylene wax.

TABLE 6
The thermal conductivity of the ATH composition of the present invention
70:30 (ATHE2) and the known ATH composition APYRAL ™
20X, when in a composite with a polyethylene wax.

| | | Thermal conductivity |
|---|---|---|
| Sample | Polymer Matrix | W/mK (at 23° C.) |
| APYRAL ™ 20X | PE Wax | 2.49 |
| Ratio 70:30 (ATHE2) | PE Wax | 2.86 |

The ATH composition of the present invention 70:30 (ATHE2) and APYRAL™ 20X show relatively high thermal conductivity when blended in a polyethylene wax.

When used in this specification and claims, the terms “comprises” and “comprising” and variations thereof mean that the specified features, steps or integers are included. The terms are not to be interpreted to exclude the presence of other features, steps or components.

The features disclosed in the forgoing description, or the following claims, or the accompanying drawings, expressed in their specific forms or in terms of a means for performing the disclosed function, or a method or process for attaining the disclosed results, as appropriate may, separately, or in any combination of such features, be utilised for realising the invention in diverse forms thereof.

1. An aluminium trihydroxide composition, wherein the aluminium trihydroxide composition comprises:
from 50 weight % to 85 weight % a first plurality of ground aluminium trihydroxide particles having a maximum dimension of from 50 to 500 μm;
from 15 weight % to 50 weight % a second plurality of ground aluminium trihydroxide particles having a maximum dimension of less than 50 μm.

2. The aluminium trihydroxide composition of claim 1, wherein the first plurality of ground aluminium trihydroxide particles have a maximum dimension of: from 50 to 300 μm; or, from 75 to 250 μm; or, from 100 to 150 μm (plus or minus 50 μm for each).

3. The aluminium trihydroxide composition of claim 1, wherein the second plurality of ground aluminium trihydroxide particles have a maximum dimension of: less than 40 μm; or, less than 30 μm (plus or minus 5 μm for each).

4. The aluminium trihydroxide composition of claim 1, wherein the first plurality of ground ATH particles has:
a D10 of from 25 to 40 μm; or from 25 to 35 μm; or from 31 to 33 μm; or 32 μm; and/or,
a D50 of from 90 to 110 μm; or from 100 to 104 μm; or 102 μm; and/or,
a D97 of from 200 to 300 μm; or from 200 to 220 μm; or 210 μm.

5. The aluminium trihydroxide composition of claim 1, wherein the second plurality of ground ATH particles has:
a D10 of from 1.0 to 4.0 μm; or from 1.0 to 2.0 μm; or 1.5 μm; and/or,
a D50 of from 6 to 12 μm; or 8 μm; and/or,
a D97 of from 25 to 40 μm; or from 30 to 34 μm; or 32 μm.

6. The aluminium trihydroxide composition of claim 1, wherein the aluminium trihydroxide composition has:
a D10 of from 1 to 3 μm; or 2 μm; and/or,
a D50 of from 20 to 24 μm; or 21.86 μm; and/or,
a D97 of from 180 to 220 μm; or 198 μm.

7. The aluminium trihydroxide composition of claim 1, wherein the first plurality of ground aluminium trihydroxide particles have a total cumulative volume of: 76 mm³/g or less; or, from 76 mm³/g to 50 mm³/g; or, from 76 mm³/g to 65 mm³/g.

8. The aluminium trihydroxide composition of claim 1, wherein the first plurality of ground aluminium trihydroxide particles have a Specific Surface Area of: 3 m²/g or less; or, 2.95 m²/g or less; or, from 3 m²/g to 1 m²/g; or, from 2.95 m²/g to 2.8 m²/g.

9. The aluminium trihydroxide composition of claim 1, wherein the aluminium trihydroxide composition comprises the first plurality of ground aluminium trihydroxide particles at: from 60 to 85 weight %; or, from 65 to 80 weight %; or, from 70 to 80 weight %; or, from 55 to 65 weight %.

10. The aluminium trihydroxide composition of claim 1, wherein the aluminium trihydroxide composition comprises the second plurality of ground ATH particles at: from 15 to 40 weight %; or, from 20 to 35 weight %; or, from 20 to 30 weight %; or, from 35 to 45 weight %.

11. The aluminium trihydroxide composition of claim 1, wherein: the first plurality of ground aluminium trihydroxide particles have a maximum dimension of 300 μm; and, the second plurality of ground aluminium trihydroxide particles have a maximum dimension of 30 μm.

12. The aluminium trihydroxide composition of claim 1, wherein the ratio of the first plurality of aluminium trihydroxide particles to the second plurality of aluminium trihydroxide particles in the aluminium trihydroxide composition is (in weight %): 12.5 (first):3.5 (second), plus or minus 2.5 for each; or, 8 (first):1.5 (second), plus or minus 0.5 for each; or, 10 (first):5 (second), plus or minus 1 for each; or, 4 (first):2.2 (second), plus or minus 0.5 for each.

13. The aluminium trihydroxide composition of claim 1, wherein the ratio of the first plurality of ground aluminium trihydroxide particles to the second plurality of ground aluminium trihydroxide particles results in: 40 or less % v/v voids (or pores) in the aluminium trihydroxide composition; or, 34 or less % v/v voids (or pores) in the aluminium trihydroxide composition.

14. The aluminium trihydroxide composition of claim 1, wherein the aluminium trihydroxide composition has a density of 2.42 g/cm³ (plus or minus 0.2 g/cm³).

15. The aluminium trihydroxide composition of claim 1, wherein the aluminium trihydroxide composition has a homogeneous particle distribution for both the first plurality of ground ATH particles and the second plurality of ground ATH particles.

16. The aluminium trihydroxide composition of claim 1, wherein the particles in the aluminium trihydroxide composition have a maximum dimension distribution of from 0.1 to 305 μm.

17. A process for making an aluminium trihydroxide composition, the process comprising the following steps:
providing a first plurality of ground aluminium trihydroxide particles, having a maximum dimension of from 50 to 500 μm at from 50 weight % to 85 weight %; and,
providing a second plurality of ground aluminium trihydroxide particles, having a maximum dimension of less than 50 μm at from 15 weight % to 50 weight %; and,
mixing the first plurality of ground aluminium trihydroxide particles and the second plurality of ground aluminium trihydroxide particles.

18. The process of claim 17, wherein the aluminium trihydroxide composition, the first plurality of ground aluminium trihydroxide particles and/or the second plurality of ground aluminium trihydroxide particles are as in claim 1.

19. The process of claim 17, wherein the step of mixing is carried out for: from 0.1 to 8 hours at 25° C.; or, from 0.3 to 4 hours at 25° C.; or, from 0.5 to 2 hours at 25° C.; or, until a mixture with a homogeneous particle distribution is formed at 25° C.

20. The process of claim 17, wherein the ratio of the first plurality of ground aluminium trihydroxide particles to the second plurality of ground aluminium trihydroxide particles in the mixture is (in weight %): 12.5 (first):3.5 (second), plus or minus 2.5 for each; or, 8 (first):1.5 (second), plus or minus 0.5 for each; or, 10 (first):5 (second), plus or minus 1 for each; or, 4 (first):2.2 (second), plus or minus 0.5 for each.

21. The aluminium trihydroxide composition of claim 1, for use as a flame retardant and/or as a thermal management filler.

22. A polymer composite comprising a polymer and the aluminium trihydroxide composition of claim 1.

23. The polymer composite of claim 22, wherein the polymer is a polymer formed from silicones, epoxies, polyesters, polyethylene wax and/or polyols; optionally, wherein the polymer is a thermoset polymer or a thermoplastic polymer.

24. The polymer composite of claim 22, wherein the polymer composite comprises (in weight %):
50 to 90 aluminium trihydroxide composition of claim 1; and,
10 to 50 polymer; or
60 to 80 aluminium trihydroxide composition of claim 1; and,
20 to 40 polymer.

25. The polymer composite of claim 22, wherein the polymer composite has a thermal conductivity of: from 2 to 7 W/mK; from 2 to 4 W/mK; or, from 2.5 to 3 W/mK; or, from 2.6 to 2.9 W/mK; or, from 2.8 to 2.9 W/mK.

26. The polymer composite of claim 22 any one of claims 22, wherein the polymer composite has a viscosity of: 13 Pa·s or less; or, 11 Pa·s or less; or, 9 Pa·s or less.
